(19) United States
(12) Patent Application Publication
(10) Pub. No.: US 2014/0026183 A1
(43) Pub. Date: Jan. 23, 2014

(54) INFORMATION PROCESSING DEVICE AND COMPUTER PROGRAM PRODUCT

(71) Applicant: KABUSHIKI KAISHA TOSHIBA, Tokyo (JP)

(72) Inventors: Jun KANAI, Tokyo (JP); Hiroshi Isozaki, Kanagawa (JP); Ryuiti Koike, Kanagawa (JP)

(73) Assignee: KABUSHIKI KAISHA TOSHIBA, Tokyo (JP)

(21) Appl. No.: 13/946,054

(22) Filed: Jul. 19, 2013

(30) Foreign Application Priority Data
Jul. 23, 2012 (JP) 2012-163059

(51) Int. Cl. G06F 21/52

(52) U.S. Cl. CPC G06F 21/52
USPC 726/1

(57) ABSTRACT

According to an embodiment, an information processing device includes a kernel configured to execute a system call, and a managing unit configured to determine whether or not to permit execution of the system call. The kernel includes a holding unit and a system call executing unit. The holding unit holds execution of the system call until a result of determination as to whether or not to permit execution of the system call is returned from the managing unit. The system call executing unit executes the system call.

### CROSS-REFERENCE TO RELATED APPLICATION(S)

This application is based upon and claims the benefit of priority from Japanese Patent Application No. 2012-163059, filed on Jul. 23, 2012; the entire contents of which are incorporated herein by reference.

### FIELD

An embodiment described herein relates generally to an information processing device and a computer program product.

### BACKGROUND

In recent years, there have been demands for restricting functions of information terminals according to the environments in which the information terminals are used, but required conditions often vary depending on the security policies in the use environments, and it is necessary that the restrictions can be flexibly modified.

In a case of a design in which a kernel determines whether or not to permit execution of a system call, however, if it is attempted to set conditions of system call execution to address various detailed conditions, source codes of the kernel itself need to be frequently modified, and there remains problems in terms of labor and maintenance. In particular, for flexibly modifying security control as described above, source codes of the kernel itself need to be frequently modified, and there is therefore a problem of cost if it is attempted to realize such modification only with the kernel of the related art.

### BRIEF DESCRIPTION OF THE DRAWINGS

FIG. 1 is a diagram illustrating a configuration of an information processing device according to an embodiment;

FIG. 2 is a table illustrating examples of data of execution requests stored in a request storage unit according to the embodiment;

FIG. 3 is a table illustrating an example of data defining default operation according to the embodiment;

FIG. 4 is a flowchart of processing for determination on execution of a system call according to the embodiment;

FIG. 5 is a flowchart of processing for registration of a management application according to the embodiment;

FIG. 6 is a flowchart of processing until execution of a system call is held according to the embodiment;

FIG. 7 is a flowchart of processing for determination on execution of a system call according to the embodiment;

FIG. 8 is a flowchart of processing for cancelling holding of a system call according to the embodiment; and

FIG. 9 is a flowchart of processing for deleting registration of the management application according to the embodiment.

### DETAILED DESCRIPTION

According to an embodiment, an information processing device includes a kernel; and a managing unit configured to determine whether or not to execute a system call. The kernel includes a request storage unit, a request notifying unit, a second acquiring unit, a holding unit, and a system call executing unit. The request storage unit is configured to store therein system call information containing information including identification information and content of execution of the system call associated with each other when a request for execution of the system call is made by an application. The request notifying unit is configured to notify the managing unit of the identification information of the system call. The second acquiring unit is configured to acquire, from the managing unit, information indicating whether or not to permit execution of the system call and holding of the execution. The holding unit is configured to hold execution of the system call until the second acquiring unit acquires the information indicating whether or not to permit the execution. The system call executing unit is configured to execute the system call. The managing unit includes a first acquiring unit, an execution determining unit, and a determination result notifying unit. The first acquiring unit is configured to acquire the content of execution from the request storage unit on a basis of the identification information of the system call notified by the request notifying unit. The execution determining unit is configured to determine whether or not the acquired content of execution can be executed according to a predetermined determination rule. The determination result notifying unit is configured to transmit a result of whether or not to permit the execution to the kernel. The request storage unit stores therein the received information indicating whether or not to permit the execution in association with the stored identification information of the system call. The holding unit determines whether or not to cancel holding of the execution of the system call on a basis of the information indicating whether or not to permit the execution and holding of the execution stored in the request storage unit and acquired by the second acquiring unit. When the holding of the execution of the system call is cancelled, the system call executing unit executes the system call.

An embodiment will be described in detail below with reference to the drawings. Note that the present invention is not limited to the embodiment.

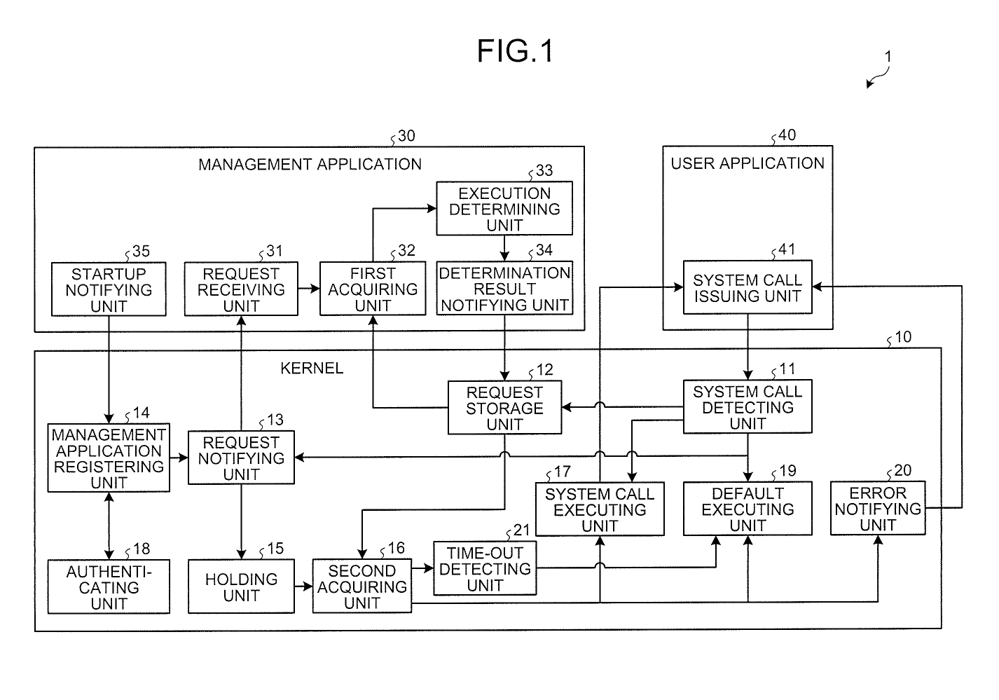

FIG. 1 is a block diagram illustrating a functional configuration of an information processing device 1 according to the embodiment. As illustrated in FIG. 1, the information processing device 1 includes a kernel 10, a management application 30 (managing unit), and a user application 40. The kernel 10 manages devices, memories and processes, and provides an application with predetermined functions in response to a system call. The management application 30 determines whether or not to permit execution of a system call requested of the kernel 10, and notifies the kernel 10 of the result thereof. The kernel 10 performs processing in response to the system call on the basis of the determination result from the management application 30. The user application 40 is a general term for applications other than the management application 30.

The kernel 10 includes a system call detecting unit 11, a request storage unit 12, a request notifying unit 13, a management application registering unit 14, a holding unit 15, a second acquiring unit 16, a system call executing unit 17, an authenticating unit 18, a default executing unit 19, a time-out detecting unit 21, and an error notifying unit 20. The system call detecting unit 11 detects a system call requested of the kernel 10 by a system call issuing unit 41 of the user application 40. The system call detecting unit 11 sends information of the detected system call to the request storage unit 12 and the request notifying unit 13.

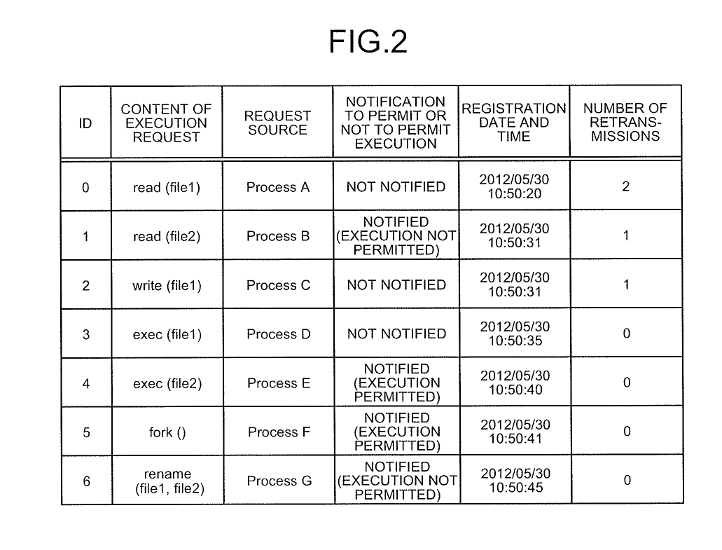

The request storage unit 12 stores therein the information of the detected system call (system call information). FIG. 2 is a table illustrating an example of a data format of the system call information stored in the request storage unit 12. As illustrated in FIG. 2, the system call information refers to information containing at least information in which an ID that is identification information and a content of execution of a system call are associated. For example, the system call information is information in which items of an ID that is identification information of the detected system call, the content of an execution request such as read or write, identification information of a process of a request source, determination information as to whether or not to permit execution from the management application 30, the date and time of storage in the request storage unit 12, and the number of retransmissions are associated. In this manner, information other than the information in which an ID that is identification information and a content of execution of a system call are associated may further be associated. The information as to whether or not to permit execution is stored as “not notified” at the point when the information is sent from the system call detecting unit 11, and updated thereafter in response to a notification to permit or not to permit execution from the management application 30. The number of retransmissions is incremented by 1 each time. The retransmission process is performed in such a case in which the determination result as to whether or not to permit execution is not returned and a time-out occurs when system call information is sent from the request notifying unit 13 to the management application 30, or in like cases. When a retransmission process is performed, the registration date and time is also updated.

The request notifying unit 13 notifies the management application 30 of the identification information of a system call. The notification is made by specifying the management application 30 stored in the management application registering unit 14. The management application registering unit 14 receives a notification requesting the kernel 10 registration at startup of the management application 30, and registers identification information of a process of the management application 30 after authentication by the authenticating unit 18 as to whether the management application 30 is a right application to be notified of the system call information, for example. For the authentication, information specific to the management application, such as a file name or a hash of an executable file, an owner name of an executable file, and signature information, is used. Such information for authentication is also stored in the kernel 10 in advance, and when authentication information notified by the management application 30 and the stored information match with each other, the management application registering unit 14 registers identification information of a process of the management application 30. Note that the authenticating unit 18 is not an essential component, and the configuration may be such that the management application 30 for which an inquiry is made is registered.

When system call information is transferred, the holding unit 15 holds execution of the system call by the system call executing unit 17 until a notification to permit or not to permit the execution is given from the management application 30. Holding of execution is realized by context switch for other processes or the like, and a register before holding and information specific to the operating system are saved. The second acquiring unit 16 acquires information as to whether or not to permit execution notified from the management application 30 and stored in the request storage unit 12, and determines whether or not to permit execution of a system call. When the second acquiring unit 16 determines that execution is permitted or that execution is not permitted, that is, when notification to permit or not to permit execution is given, the holding unit 15 cancels holding of execution of the system call. The second acquiring unit 16 may have a function of calling the time-out detecting unit 21 so as to determine whether or not notification of information as to whether or not to permit execution has not been given for a predetermined time or longer.

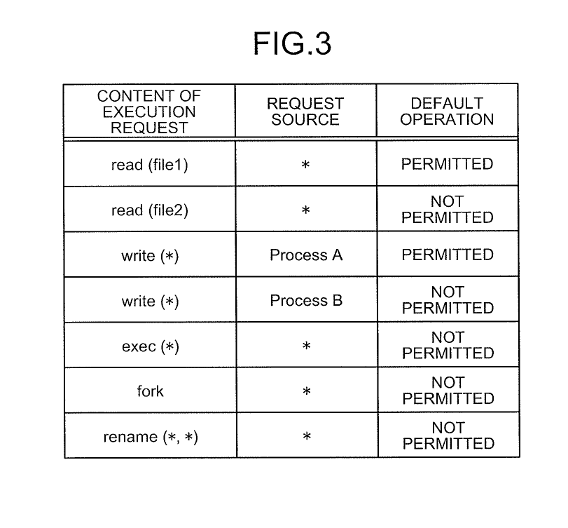

The system call executing unit 17 executes a system call holding of which is cancelled by the holding unit 15. The system call executing unit 17 notifies the user application 40 of a result obtained by executing a system call. When a system call is detected in a case where the management application 30 is not registered, the default executing unit 19 executes default operation that is registered in advance. FIG. 3 illustrates an example of data defining the default operation for each content of execution request. For example, when the content of execution is “read (file 1)”, the default operation is “permitted”, and therefore the system call is executed. An example of an execution request that is “permitted” is one with a content that does not cause a security failure when the system call is executed.

The time-out detecting unit 21 determines whether or not a predetermined time has elapsed since a previous request for determination on a system call is notified to the management application 30 on the basis of the information in the field of the registration date and time. If a predetermined time has elapsed, the time-out detecting unit 21 retransmits the request for determination on the system call to the management application 30 via the request notifying unit 13. The time-out detecting unit 21 also calls the default executing unit 19 when the number of retransmission of the determination request by the request notifying unit 13 exceeds a predetermined limit of the number of retransmissions. Note that the time-out detecting unit 21 is not an essential component.

When it is determined that execution of a system call cannot be performed for some reason such as in a case where execution of a system call is determined not to be permitted by the management application 30, the error notifying unit 20 notifies the user application 40 of the same.

The management application 30 includes a request receiving unit 31, a first acquiring unit 32, an execution determining unit 33, a determination result notifying unit 34, and a startup notifying unit 35. The request receiving unit 31 receives identification information of a system call notified by the kernel 10, and transfers the received identification information to the first acquiring unit 32. The first acquiring unit 32 refers to the request storage unit 12, and acquires the content of the corresponding system call request by using the identification information of the system call. Execution of the acquired content of the system call request is determined to be permitted or not to be permitted by the execution determining unit 33. For the determination as to whether or not to permit execution, a storage unit in which a determination rule is defined may be provided in the management application 30 or a determination rule may be acquired from another device via a network. The determination result notifying unit 34 notifies the request storage unit 12 of the result of determination as to whether or not to permit execution of the system call made by the execution determining unit 33 together with the identification information. The request storage unit 12 updates the information as to whether or not to permit execution with the identification information of the system call and the determination result on whether or not to permit execution that are notified.

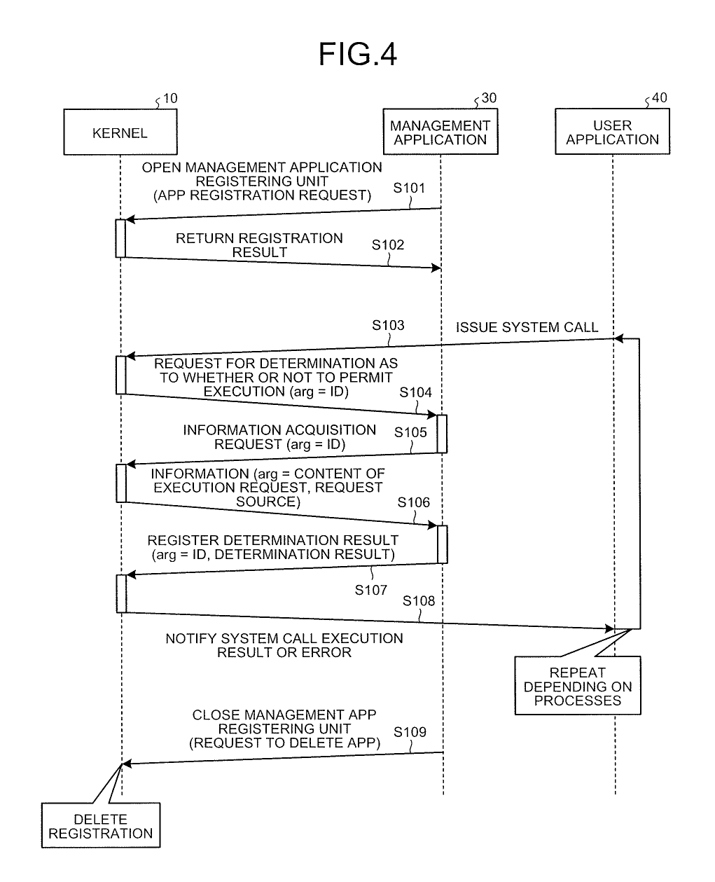

Next, a flow of processing a system call according to the embodiment will be described with reference to FIG. 4. As illustrated in FIG. 4, the management application 30 first transmits an open request, that is, a request for registering the application to the management application registering unit 14 of the kernel 10 at startup (step S101). The management application registering unit 14 returns the result of registration to the management application 30 (step S102)

In addition, the user application 40 issues a system call from the system call issuing unit 41 to the kernel 10 (step S103). The request notifying unit 13 of the kernel 10 transmits the determination as to whether or not to permit execution to the management application 30 with specified identification information of the system call (step S104). The first acquiring unit 32 of the management application 30 specifies the identification information and requests the request storage unit 12 of the kernel 10 to acquire the content of the system call (step S105). The request storage unit 12 of the kernel 10 returns the content of a system call execution request identified by the specified identification information and the process name of the request source to the management application 30 (step S106). The management application 30 returns the determination result, and updates the information of the corresponding system call execution request in the request storage unit 12 of the kernel 10 (step S107). The kernel 10 notifies the user application 40 of the result of execution of the system call, or an error notification if the execution is failed (step S108). Finally, the management application 30 transmits a request to close the management application registering unit 14, that is, a request to delete the management application from registration to the kernel 10 at shutdown or the like (step S109).

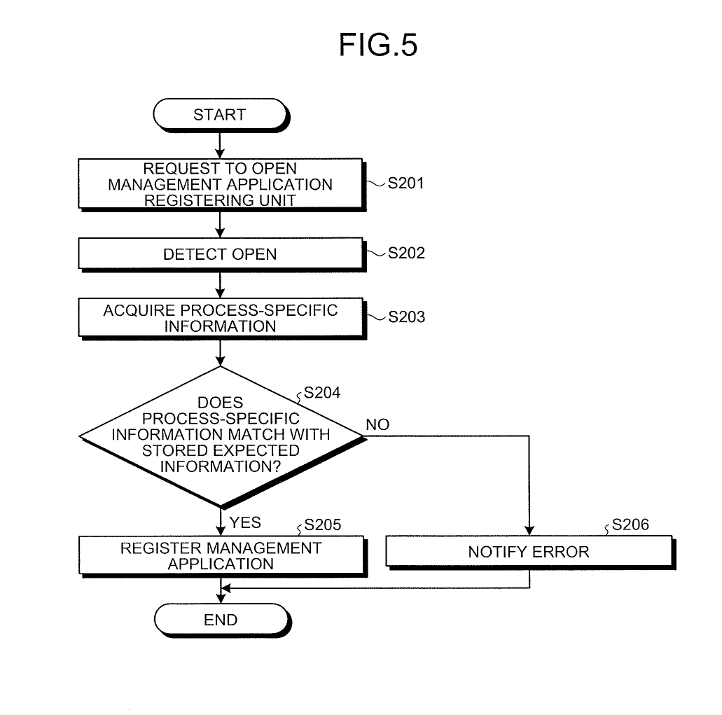

Next, processing for registration of the management application will be described in detail with reference to FIG. 5. As illustrated in FIG. 5, the startup notifying unit 35 transmits an open request of the management application to the management application registering unit 14 (step S201). When the open request is detected (step S202), the management application registering unit 14 acquires process-specific information of the management application, that is, information such as the file name and a hash of the file of the management application (step S203).

The authenticating unit 18 then determines whether or not expected information stored in the kernel 10 in advance and the process-specific information acquired from the management application 30 match with each other (step S204). If the expected information and the acquired process-specific information match with each other (step S204: Yes), the management application registering unit 14 registers the management application 30 as a right management application and terminates the processing (step S205). If, on the other hand, the expected information and the acquired process-specific information to not match with each other (step S204: No), the management application registering unit 14 gives an error notification that the registration is failed to the management application 30 (step S206). Note that the processing from step S203 to step S204 and in step S206 is not essential.

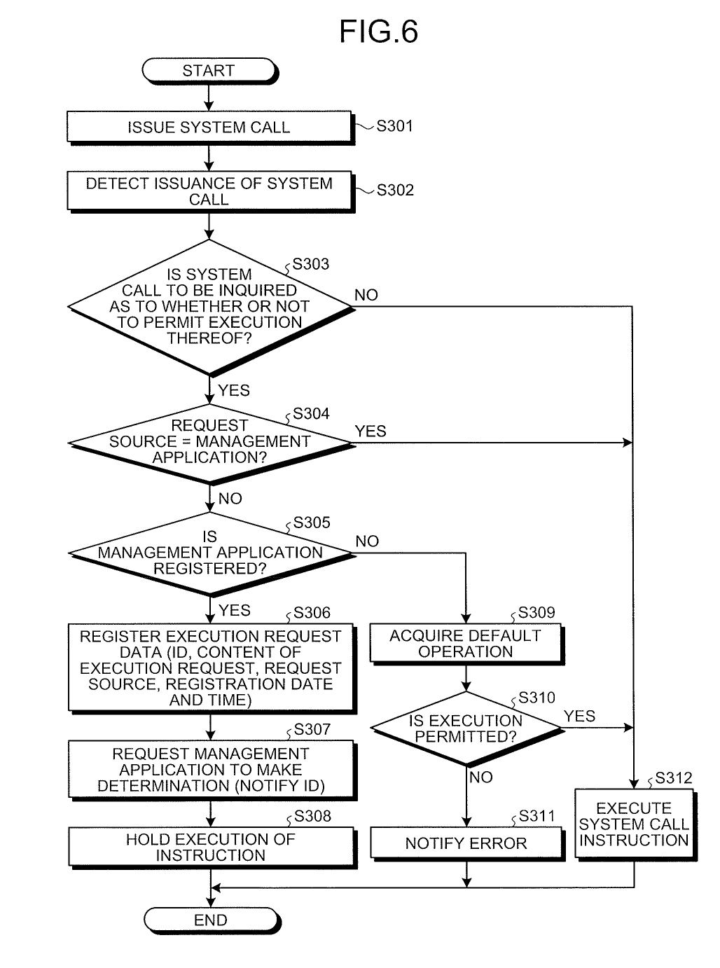

Next, a flow of processing from detection of a system call to holding of execution the system call will be described with reference to FIG. 6. As illustrated in FIG. 6, when a system call is issued by the system call issuing unit 41 (step S301), the system call is detected by the system call detecting unit 11 of the kernel 10 (step S302). Subsequently, the system call detecting unit 11 determines whether or not the system call is a process for which an inquiry as to whether or not to permit execution thereof is to be made to the management application 30 (step S303). Whether or not to make an inquiry as to whether or not to permit execution can be determined in advance on the basis of the content of the system call, and the configuration can be such that an inquiry is omitted for a Wi-Fi connection request, for example. Note that the processing in step S303 is not essential.

If it is determined that the system call is a process for which an inquiry is to be made to the management application 30 (step S303: Yes), it is then determined whether or not the request source of the system call is the management application 30 (step S304). Specifically, if the request source is the management application 30, it is obviously not necessary to make an inquiry as to whether or not to permit execution to the management application 30, and therefore the system call is excluded from those for which an inquiry is to be made. If the system call is not a process for which an inquiry is to be made (step S303: No) or if the request source is the management application 30 (step S304: Yes), the system call executing unit 17 executes the system call, and terminates the processing (step S312).

If, on the other hand, the request source is not the management application 30 (step S304: No), the management application registering unit 14 determines whether or not the management application 30 is registered (step S305). If it is determined that the management application 30 is registered (step S305: Yes), the request storage unit 12 registers data of the system call execution request (step S306). The content of the registration includes the identification information of the system call, the content of the execution request, the request source and the registration date and time. In addition, the information as to whether or not to permit execution is “not transmitted”. Subsequently, the request notifying unit 13 specifies the identification information of the system call and requests the management application 30 to make determination (step S307). The holding unit 15 then holds execution of the system call and the processing is terminated (step S308). Note that the processing in step S304 is not essential.

If, on the other hand, it is determined that the management application 30 is not registered (step S305: No), the default executing unit 19 acquires default operation (step S309). The default executing unit 19 then determines whether or not execution of the content of the system call request is permitted on the basis of the acquired default operation (step S310). If the execution is permitted (step S310: Yes), the default executing unit 19 executes the execution request of the system call, and terminates the processing (step S312). If, on the other hand, the execution is not permitted (step S310: No), the error notifying unit 20 makes error notification to the user application 40 (step S311).

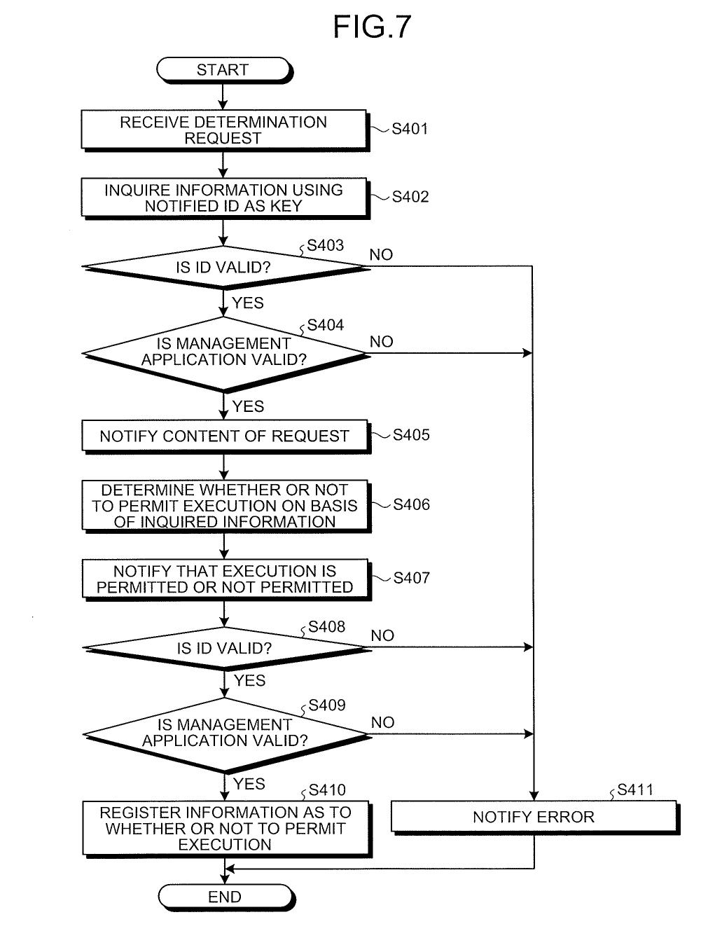

Next, processing for determining whether or not to permit execution of a system call made at the management application 30 will be described in detail with reference to FIG. 7. When the request receiving unit 31 receives a request for determining execution of a system call from the request notifying unit 13 (step S401), the first acquiring unit 32 inquires of the request storage unit 12 the corresponding content of the execution request by using the identification information of the received system call as a key (step S402). Subsequently, the request storage unit 12 determines whether or not the identification information for which the inquiry is made is a valid ID, that is, whether the identification information is stored in the request storage unit 12 (step S403). If it is determined that the identification information for which the inquiry is made is a valid ID (step S403: Yes), the request storage unit 12 then determines whether the management application 30 for which the inquiry is made is a registered application (step S404). If it is determined that the identification information for which the inquiry is made is not a valid ID (step S403: No) or if it is determined that the management application 30 for which the inquiry is made is not a registered application (step S404: No), the request storage unit 12 makes an error notification to the management application 30 (step S411), and terminates the processing.

If, on the other hand, it is determined that the management application 30 for which an inquiry is made is a registered application (step S404: Yes), the request storage unit 12 transmits the content of the execution request to the first acquiring unit 32 (step S405). The execution determining unit 33 determines whether or not to permit execution on the basis of the inquired information of the execution request (step S406), and the determination result notifying unit 34 notifies the request storage unit 12 that the execution is permitted or not permitted (step S407).

The request storage unit 12 determines whether or not the identification information of the management application 30 from which the notification is a valid ID, that is, whether the identification information is stored in the request storage unit 12 (step S408). If it is determined that the identification information with which the notification is made is a valid ID, the request storage unit 12 then determines whether the management application 30 from which the notification is made is a registered application (step S409). If it is determined that the identification information with which the notification is made is not a valid ID (step S408: No) or if it is determined that the management application 30 from which the notification is made is not a registered management application (step S409: No), the request storage unit 12 makes an error notification to the management application 30 (step S411), and terminates the processing.

If it is determined that the management application 30 from which the notification is made is a registered management application (step S409: Yes), the request storage unit 12 updates the corresponding information of the execution request on the basis of the notified information as to whether or not to permit execution (step S410), and terminates the processing.

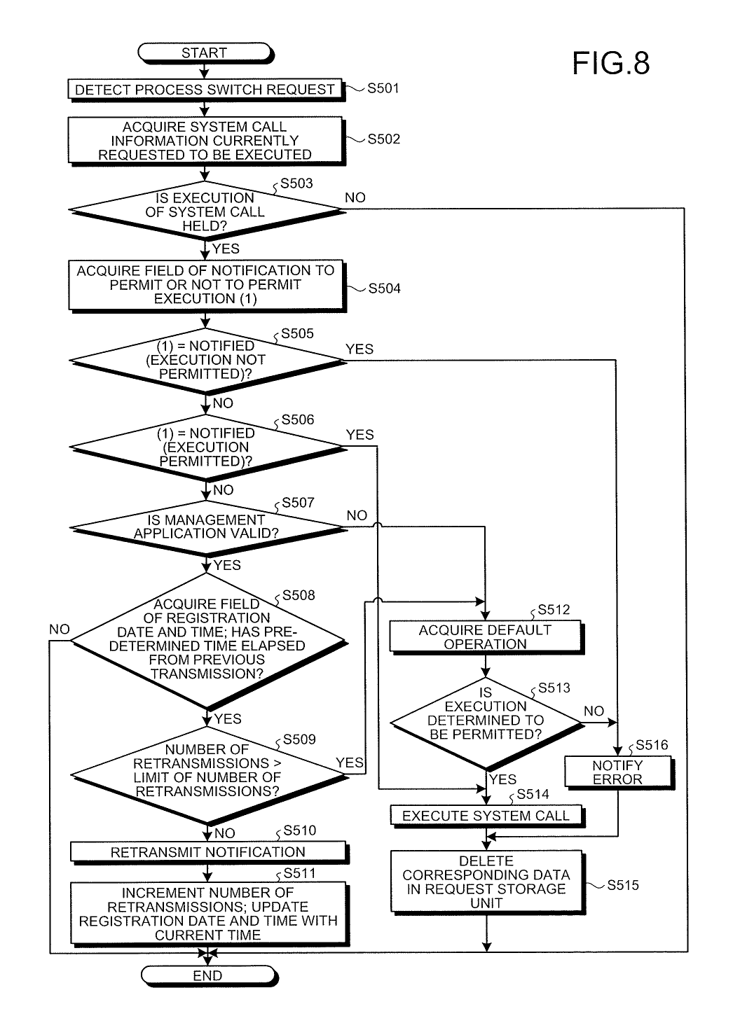

Next, a flow of processing for cancelling holding of a system call will be described with reference to FIG. 8. As illustrated in FIG. 8, the processing is started each time a process switch request is detected (step S501). The process switch request may be made by explicitly issuing a switch instruction or may be made by being called by timer interruption at regular intervals. The second acquiring unit 16 acquires from the request storage unit 12 information on a system call with a process name of the request source that matches with the identification information of a process resulting from the switching (step S502). The second acquiring unit 16 then determines whether or not execution of the system call of the current process resulting from the switching is being held, that is, whether or not the process name of the request source that match with the identification information of the current process is stored in the request storage unit 12 (step S503). If it is determined that execution of the system call of the current process resulting from the switching is not being held (step S503: No), the processing is terminated.

If, on the other hand, it is determined that execution of the system call of the current process resulting from the switching is being held (step S503: Yes), the second acquiring unit 16 acquires information on notification to permit or not to permit the corresponding process in the request storage unit 12 (step S504). Subsequently, the second acquiring unit 16 determines whether or not the acquired information in the field of notification to permit or not to permit execution is “notified (execution not permitted)” (step S505). If it is determined that the acquired information in the field of notification to permit or not to permit execution is “notified (execution not permitted)” (step S505: Yes), the holding unit 15 cancels holding of the system call, the error notifying unit 20 makes error notification to the user application 40 that is the request source (step S516), and subsequently, the request storage unit 12 deletes data of the corresponding execution request (step S515), and terminates the processing.

If, on the other hand, the acquired information in the field of notification to permit or not to permit execution is not “notified (execution not permitted)” (step S505: No), it is determined whether or not the acquired information in the field of notification to permit or not to permit execution is “notified (execution permitted)” (step S506). If it is determined that the acquired information in the field of notification to permit or not to permit execution is “notified (execution permitted)” (step S506: Yes), the holding unit 15 cancels holding of the system call, and the system call executing unit 17 executes the system call (step S514). Subsequently, the request storage unit 12 deletes data of the corresponding execution request (step S515), and terminates the processing.

If it is determined that the acquired information in the field of notification to permit or not to permit execution is not “notified (execution permitted)” (step S506: No), the second acquiring unit 16 determines whether or not the process of the management application 30 exists in a valid manner (step S507). The process information of the management application 30 may be stored in the request storage unit 12 or may be stored in another storage unit. If it is determined that the process of the management application 30 is not valid (step S507: No), the default executing unit 19 acquires default operation (step S512), and determines whether or not the execution request of the process resulting from the switching is permitted on the basis of the acquired default operation (step S513). If it is determined that the execution request is not permitted (step S513: No), the error notifying unit 20 makes error notification to the user application 40 that is the system call request source (step S516), and subsequently, the request storage unit 12 deletes data of the corresponding execution request (step S515), and terminates the processing. If, on the other hand, it is determined that the execution request is permitted (step S513: Yes), the holding unit 15 cancels holding of the system call, and the system call executing unit 17 executes the system call (step S514). Subsequently, the request storage unit 12 deletes data of the corresponding execution request (step S515), and terminates the processing.

If it is determined that the process of the management application 30 exists in a valid manner (step S507: Yes), the time-out detecting unit 21 determines whether or not a predetermined time has elapsed since a previous request for determination on the system call is notified to the management application 30 on the basis of the information in the field of the registration date and time (step S508). If it is determined that the predetermined time has not elapsed (step S508: No), the processing is terminated.

If, on the other hand, it is determined that the predetermined time has elapsed (step S508: Yes), the time-out detecting unit 21 determines whether or not the number of retransmissions of the corresponding process is larger than a predetermined limit of the number of retransmissions (step S509). If it is determined that the number of retransmissions is larger than the limit of the number of retransmissions (step S509: Yes), the processing for determining whether or not to permit execution at the management application 30 can be unavailable owing to some cause, and therefore, the processing proceeds to that from step S513 performed by the default executing unit 19.

If it is determined that the number of retransmissions is equal to or smaller than the limit of the number of retransmissions (step S509: No), the request notifying unit 13 retransmits the request for determining whether or not to permit execution of the system call to the management application 30 (step S510). The request storage unit 12 increments the value of the number of retransmissions by 1, and updates the information of the registration date and time with the current time (step S511).

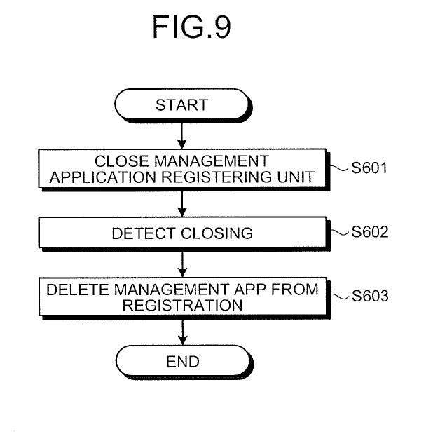

Next, processing for closing the management application 30 after executing a system call will be described with respect to FIG. 9. As illustrated in FIG. 9, the management application 30 transmits a close request to the management application registering unit 14 (step S601). When the close request is detected (step S602), the management application registering unit 14 deletes the process information of the management application 30 from the authenticating unit 18 (step S603).

Since the information processing device 1 according to the embodiment described above has a configuration in which the kernel 10 and the management application 30 that determines execution of a system call are provided separately, respective programs therefor can be designed individually, which can increase the design flexibility. Moreover, since the management application 30 is registered in the kernel 10 after the process information thereof is authenticated at startup and the kernel 10 regards only a determination result on whether or not to permit execution of the management application 30 with a registered process as valid information, it is possible to prevent wrongful use of communication protocols between different applications for unauthorized processing.

Furthermore, in cases where process information of the management application is not registered, the contents of requests for execution of system calls to be permitted are defined as default in advance, which can increase the flexibility of processing. Furthermore, if the rule for determination on system call execution requests is updated through communication with an external server or the like via a network, the updating thereof is facilitated and the maintenance cost can be reduced.

Note that the kernel and the functions of the management application in the information processing device according to the embodiment described above may be provided as programs. In this case, the programs are recorded on a computer readable recording medium such as a CD-ROM, a flexible disk (FD), a CD-R, and a digital versatile disk (DVD) in a form of a file that can be installed or executed, and provided therefrom.

Alternatively, the programs may be stored on a computer system connected to a network such as the Internet, and provided by being downloaded via the network. Still alternatively, the programs may be provided or distributed through a network such as the Internet.

Still alternatively, the programs may be embedded in a ROM or the like in advance and provided therefrom.

If, however, a generating unit and a transfer instructing unit are provided as programs, the programs are read out from a storage medium and executed by an electronic circuit or a processor different from the CPU (processor), whereby the units are loaded onto a main storage unit and the generating unit and the transfer instructing unit are generated thereon in an actual hardware configuration.

Situations in which the invention according to the embodiment described above is utilized will be described below. Software mounted on the information processing device includes an underlying operating system and various application programs running thereon. Data stored in the information processing device are managed in the form of files by the operating system. When an application program accesses (reads, writes, etc.) data in a storage, a system call requesting operation of a file (such as creation of, writing into, reading from, and deleting from a file) to the operating system. A part of the operating system that manages files may also be referred to as a file system.

In the meantime, with the increase of information terminals such as tablets and smart phones used in mobile applications, software in such terminals has changed from that provided from a single supplier and preinstalled as in the past to applications that can be additionally installed and customized freely by users. Control on whether or not to permit an event such as a system call that has occurred used to be integrated into a part called kernel, but as operation development environment for third parties such as Android (registered trademark) is improved, configurations for event processing are increasingly produced and distributed by different independent organizations for different functions.

In particular, when mobile terminals such as tablets and smart phones are to be used for business applications, it is required to limit the functions of the terminals according to policies of respective companies. For example, for a certain company, it may be required to prohibit connection of external storage devices such as external USB memories and SD cards with the terminals in order to prevent leakage of information stored in the tablets. For another company, connection with external storage devices may be permitted but it may be required to prohibit connection with Bluetooth (registered trademark) devices. In this manner, required conditions often vary depending on the security policies of respective companies, and it is necessary that the restrictions can be flexibly modified. For flexibly modifying security control in such circumstances, source codes of a kernel itself need to be frequently modified, and there is therefore a problem of cost if it is attempted to realize such modification only with the kernel of the related art. With the present invention according to the embodiment, however, this problem can be solved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a kernel; and
a managing unit configured to determine whether or not to execute a system call, wherein
the kernel includes:
a request storage unit configured to store therein system call information containing information including identification information of the system call and content of execution of the system call associated with each other when a request for execution of the system call is made by an application;
a request notifying unit configured to notify the managing unit of the identification information of the system call;
a second acquiring unit configured to acquire, from the managing unit, information indicating whether or not to permit execution of the system call and holding of the execution of the system call;
a holding unit configured to hold execution of the system call until the second acquiring unit acquires the information indicating whether or not to permit the execution; and
a system call executing unit configured to execute the system call, and
the managing unit includes:
a first acquiring unit configured to acquire the content of execution from the request storage unit on a basis of the identification information of the system call notified by the request notifying unit;
an execution determining unit configured to determine whether or not the acquired content of execution can be executed according to a predetermined determination rule; and
a determination result notifying unit configured to transmit a result of whether or not to permit the execution to the kernel,
the request storage unit stores therein the received information indicating whether or not to permit the execution in association with the stored identification information of the system call,
the holding unit determines whether or not to cancel holding of the execution of the system call on a basis of the information indicating whether or not to permit the execution and holding of the execution stored in the request storage unit and acquired by the second acquiring unit, and
when the holding of the execution of the system call is cancelled, the system call executing unit executes the system call.

2. The information processing device according to claim 1, further comprising:
an authenticating unit configured to authenticate the managing unit at startup of the information processing device; and
a registering unit configured to register identification information of the authenticated managing unit.

3. The information processing device according to claim 1, wherein the kernel further includes:
a time-out detecting unit configured to detect that the information indicating whether or not to permit the execution has not been notified by the managing unit for a predetermined time, and retransmits the execution request to the request notifying unit when the number of retransmissions is equal to or smaller than a predetermined number; and
a default executing unit configured to acquire predetermined default operation when the number of retransmissions exceeds the predetermined number or when no registered managing unit exists, and execute the system call on a basis of the default operation.

4. The information processing device according to claim 1, wherein the kernel further includes:
a default executing unit configured to check an operation status of the managing unit, acquire predetermined default operation when the operation status is abnormal, and execute the system call on a basis of the default operation.

5. The information processing device according to claim 1, wherein the system call executing unit executes a system call from the managing unit without the determination as to whether or not to permit execution by the managing unit.

6. A computer program product comprising a computer-readable medium containing a computer program, the program causing a computer to function as:
a kernel; and
a managing unit configured to determine whether or not to execute a system call, wherein
the kernel includes:
a request storage unit configured to store therein system call information containing information including identification information and content of execution of the system call associated with each other when a request for execution of the system call is made by an application;
a request notifying unit configured to notify the managing unit of the identification information of the system call;
a second acquiring unit configured to acquire, form the managing unit, information indicating whether or not to permit execution of the system call and holding of the execution;
a holding unit configured to hold execution of the system call until the second acquiring unit acquires the information indicating whether or not to permit the execution; and
a system call executing unit configured to execute the system call,
the managing unit includes:
a first acquiring unit configured to acquire the content of execution from the request storage unit on a basis of the identification information of the system call notified by the request notifying unit;
an execution determining unit configured to determine whether or not the acquired content of execution can be executed according to a predetermined determination rule; and
a determination result notifying unit configured to transmit a result of whether or not to permit the execution to the kernel,
the request storage unit stores therein the received information indicating whether or not to permit the execution in association with the stored identification information of the system call,
the holding unit determines whether or not to cancel holding of the execution of the system call on a basis of the information indicating whether or not to permit the execution and holding of the execution stored in the request storage unit and acquired by the second acquiring unit, and
when the holding of the execution of the system call is cancelled, the system call executing unit executes the system call.
